(19) United States
(12) Patent Application Publication
(10) Pub. No.: US 2006/0200408 A1
(43) Pub. Date: Sep. 7, 2006

(54) Method and system for brand management

(76) Inventor: David Gryce, Washington, DC (US)

Correspondence Address: ARENT FOX PLLC, 1050 CONNECTICUT AVENUE, N.W., SUITE 400, WASHINGTON, DC, 20036, US

(21) Appl. No.: 11/238,999

(22) Filed: Sep. 30, 2005

Related U.S. Application Data
(60) Provisional application No. 60/614,425, filed on Sep. 30, 2004.

(51) Int. Cl. G06Q 40/00

(52) U.S. Cl. 705/40

(57) ABSTRACT

A method of and system for managing brands for products and services internationally. The method includes receiving identification of a package of legal services, receiving a selection for membership of a core team, determining a subscription for the package of legal services, and generating a bill based on the package of legal services, any legal services performed, the subscription, and a subscription rate

### CROSS-REFERENCES TO RELATED APPLICATIONS

This application claims priority to U.S. Provisional Application Ser. No. 60/614,425 filed on Sep. 30, 2004, the contents of which are hereby incorporated by reference in their entirety.

### BACKGROUND OF THE INVENTION

1. Field of the Invention

The present invention is directed to a method of and system for managing legal services, and in particular to a method of and system for billing packaged trademark services associated with product and service brand management.

2. Description of the Related Art

Traditionally, consumer product and service companies have relied upon their product and service brands as their foundation for their marketing, promotion, and advertising initiatives. Product and service trademarks provide the consuming market with distinguishable identifiers of source that assist consumers with purchasing decisions. In addition, brands allow vendors to differentiate their products and services from those of their competitors. An important part of brand protection is obtaining and enforcing trademark rights, both nationally and abroad.

For a company wishing to excel in the international marketplace, managing and protecting the trademark(s) of the company can be complicated and costly. For instance, the law of trademarks is fragmented into a patchwork of national jurisdictions. In the United States, for example, state, federal, and common law trademarks all play a role. Therefore, an owner of consumer brands may want to register each brand in a variety of pertinent jurisdictions (state, national, or regional) in order to secure protection of such brands internationally. Hence, the number of registrations and the number of applications for registering each mark can be high, depending on the relevant countries. Moreover, the resulting number is then multiplied by the number of marks and their variations in order for the brand to roll out effectively (e.g., each logo and design version of the brand).

In addition to clearing, applying for and registering trademarks, the company must manage the marks. For instance, trademark management includes maintaining registrations, policing the use of each mark worldwide, and enforcing rights in a multitude of jurisdictions. Compounding the task of trademark management, the Internet offers a marketplace teaming with conflicting brands at the touch of a few keys, which requires constant policing.

As such, the task of managing and protecting the company's brands can be voluminous and costly, especially for an entity with limited resources.

Given the above, consumer product and service companies face several challenges in securing and managing their trademarks. Among these challenges are, for example, limited internal resources; greater demands for legal infrastructure to manage data; administrative burdens imposed by the number of trademark registrations/applications to support/protect global brands; shifting legal standards resulting from changes in national and international trademark laws; budget restrictions that prevent increasing internal staffing and resources; uneven levels of work created by new brand or corporate identity rollouts; and unanticipated increases in costs to create, maintain, police, and enforce trademark rights.

In the past, consumer product or service companies have performed their trademark management in-house, used outside counsel, or divided the workload between the two. Performing trademark management in-house generally results in an increase in human resource and information technology costs. Therefore, there is a momentum to move trademark management to outside counsel, which can leverage the expense of infrastructure and resources over a larger population of clients and client trademark portfolios. However, one drawback of using outside counsel is that law firms derive income from providing legal services. Thus, the pricing of these services can reflect a premium.

For companies that have elected to outsource some or all of their trademark management workload to outside counsel, the companies (also referred to interchangeably herein as “clients”) generally choose whether to pay for legal services by the hour or based on a fixed-fee engagement. Paying for services by the hour can impose uncertainty on a company's budget for legal services. In a fixed-fee arrangement, the outside counsel (also referred to interchangeably herein as the “firm”) commits to perform specifically delineated services for a comprehensive, fixed price. One advantage of fixed-fee billing is that a company can budget for legal services. However, one drawback is that the company is required to forecast a budget that is suitable for the company's present and future needs.

Outside counsels are also faced with issues regarding billing structures for trademark management. Law firm economics frequently rely upon the billable hour. Traditionally, success for fixed-fee engagements depends upon whether the firm received a fee that is equal to or greater than the value of the billable hours spent in providing the services. If so, the transaction is generally economically favorable. Otherwise, the transaction is unfavorable. Thus, from a firm's perspective, a fixed-fee engagement can be risky. Therefore, a firm often incorporates a premium into the fixed-fee engagement in order to cover increases or contingencies in service needs. Hence, the fixed-fee engagement pits the interests of the law firm against the interests of the company in a gamble, where there are likely a winner and a loser.

### BRIEF SUMMARY OF THE INVENTION

The present invention provides a structure and platform that embodies an effective method and system for providing brand management. One embodiment of the present invention includes a method and system for providing various trademark related and other legal services to a company, and having a billing structure for billing the company for these services that solves the foregoing challenges and issues.

One exemplary embodiment of the present invention provides a method for managing brands for products and services internationally that includes receiving a first input identifying a service as part of a packaged legal service, receiving a second input identifying a core team member associated with the service, determining a subscription for the packaged legal services, performing legal services, generating a bill based on the legal services and forwarding the bill.

One embodiment of the present invention relates to a method and system for managing brands for products and services internationally. The present invention allows a firm to provide packaged legal services to an entity, also referred to interchangeably herein as a “client”. The present invention may include comprehensive legal services relating to the clearance, acquisition, maintenance, policing, and enforcement of trademark rights internationally. For example, the present invention can focus on the provision of legal services by a team of professionals who rely upon the development of institutional familiarity with the client and its affairs. This team of professionals is referred to as the client's “core team” and can be stored in a database, such as a core team look-up table. As the core team develops a familiarity and knowledge base with respect to the client, providing the required services for the client can become more and more efficient. The core team is used to provide the client with greater certainty concerning the cost of services. In addition, the present invention can charge subscription rates for matters that have consistent, periodic requirements, and spread those ebbs and flows over a relatively large field of trademark applications and registrations. This approach allows the firm to normalize pricing.

Another embodiment of the present invention can periodically audit and adjust fees for trademark portfolio management. The fee adjustment can depend, for example, on the number of applications and registrations under management; and on the annual average increase in hourly rates of attorneys at the firm as a whole. The present invention can adjust the fees based on the number of matters for which services may be required.(the “subscription”). In addition, the present invention can monitor and adjust the subscription rate to the same extent as the fees the firm charges to remain competitive against inflation pressures.

Subject to these adjustments and certain expense items and disbursements, such as government filing fees, the present invention offers fixed rates for many services. Furthermore, the present invention is able to base the fee on an annualized fee, and payments are received in periodic installments.

In another embodiment of the invention, related services are appended to the portfolio management services and can be charged on an hourly or other basis. Such services may include advertising clearance, telemarketing, sweepstakes clearance, patent, privacy, and general e-commerce counseling services. These related services, may also be incorporated into the system and developed into subscription-based structure if regular and predictable in nature.

One particular implementation of the present invention is as follows. A portfolio management fee is calculated and charged to the client monthly. The portfolio management fee may be based on the number of trademark applications and the number of trademark registrations under management. Fees for trademark availability searches may be capped, and Internet Watch services may be billed separately on a monthly subscription basis. Incidental counseling may be included as part of the portfolio management fees. The division of workload may be structured to utilize, to the maximum extent possible, in-house resources.

In one implementation, a team of attorneys and legal assistants is dedicated to the management of a client's portfolio. In addition to trademark application filing, registration, and, in some variations, prosecution fees, which are charged on a fixed periodic basis, included in the portfolio management subscription fee may be periodic team meetings to coordinate the members of the core team. Also included in the portfolio management subscription fee may be monthly reports on upcoming due dates.

The subscription fee generally does not include advertising clearance services, trademark enforcement, telemarketing and sweepstakes counseling, privacy and e-commerce counseling, comprehensive brand strategy, or implementation services.

Other services also not included in the subscription fee include, for example, patent prosecution and litigation; licensing services; government relations services; or legal services in the fields of real estate, corporate, tax, or Consumer Product Safety Commission. If these services are needed only occasionally, they are billed, for example, at an hourly rate. However, if such services are needed on a regular basis, the services may be added to the portfolio management fee, or may be billed using a separate normalized fee. In this case, a trial period of hourly billing may first be used, so that the client and the firm can determine the appropriate rate for normalized fees.

Additional advantages and novel features of the invention will be set forth in part in the description that follows, and in part will become more apparent to those skilled in the art upon examination of the following or upon learning by practice of the invention.

### BRIEF DESCRIPTION OF THE SEVERAL VIEWS OF THE DRAWINGS

The above and other features and advantages of the present invention will become more apparent to those of ordinary skill in the art by describing in detail the exemplary embodiments thereof with reference to the attached drawings in which:

FIG. 1 illustrates a flow chart diagram showing one example of the method of and system for brand management of the present invention;

FIG. 2 illustrates a system network diagram showing one example of various hardware and software component and other features useable in accordance with an embodiment of the present invention;

FIG. 3 illustrates one example of a computer system capable of carrying out the functionality of present invention; and

FIG. 4 illustrates one example of a sample bill produced in accordance with an embodiment of the present invention.

### DETAILED DESCRIPTION OF THE INVENTION

The present invention will now be described more fully hereinafter with reference to the accompanying drawings, in which exemplary embodiments of the invention are shown. The invention may, however, be embodied in different forms and should not be construed as limited to the embodiments set forth herein. Rather, the embodiments provided are enabling to those skilled in the art.

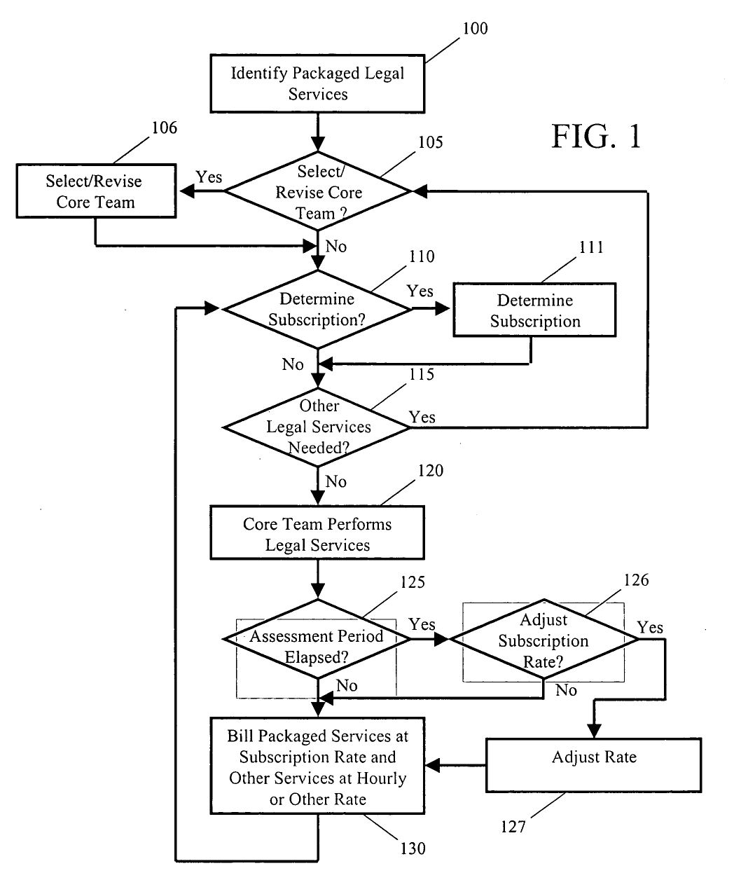

FIG. 1 shows a flow chart illustrating a method for managing brands for products and services internationally, in accordance with an embodiment of the present invention. As shown in FIG. 1, in step 100, one or more packaged legal services are identified for the client. The packaged legal services may be identified, for example, via a request for proposal (RFP). The packaged legal services may include one or more legal services related to the management of a trademark portfolio, including trademark filings and registrations. In some special cases, as discussed further below, these packaged legal services can optionally include other types of legal services that are generally predictable in scope and costs. In one exemplary implementation, the packaged legal services also include scheduling monthly team meetings to coordinate the members of the core team and generating monthly reports on upcoming due dates. The package does not include other, typically highly variable cost activities, such as providing advertisement clearance services, trademark enforcement, telemarketing and sweepstakes counseling, patent work, privacy and e-commerce counseling, and comprehensive brand strategy and implementation services.

For example, the present invention can offer the above list of legal services included in the package by displaying the list on a display screen for the user. The items on the list of legal services can be stored in memory and can be in a form of or include use of a database or other repository. Once the user selects the desired legal services from the list, the present invention receives the input of selected legal services and thereafter identifies the packaged legal services.

In step 105 a determination is made as to whether a core team needs to be selected or revised. The core team can include, for example, a plurality of legal professionals who will perform the packaged legal services identified in step 100, as well as other legal services. In some cases, the core team consists of a single individual or a combination of employees from the law firm, such as legal assistants, paralegals, secretaries, technical specialists, etc. In other cases, the core team can include legal professionals from outside the firm.

If a determination is made in step 105 that no selection or revision of the core team is needed, the method proceeds directly to step 110.

If the determination in step 105 is that a core team is to be selected or revised, in step 106, the core team is selected or revised. The core team can be selected or revised, for example, by identification using a list of names provided to the user. For example, a list of names can be displayed on a display panel for review and selection. One or more of the names on the list can have a corresponding identifier, such as a title or expertise. The list of names can be stored in memory and can also be in a form or include use of a database or other repository. In one embodiment of the present invention, the list of names can be categorized into predetermined classifications.

Once the user selects the desired names, the present invention receives the input of selected names and thereafter compiles a core team that can be associated with the identified packaged legal services.

In step 110, a determination is made as to whether a subscription for the packaged legal services is needed.

If a determination is made in step 110 that no subscription needs to be determined, (e.g., the subscription is unchanged from a previous level) the method proceeds directly to step 115.

If a determination is made in step 110 that a subscription needs to be determined, the subscription is determined in step 111. The subscription includes, for example, the number of trademark applications and the number of trademark registrations. Numbers of other regular and predictable activities may also optionally be included in the subscription or through a separate subscription.

In step 115, a determination is made as to whether other legal services than the packaged legal services are needed. If no other legal services are needed, the method proceeds to step 120. If additional legal services are needed, the method returns to step 105 to determine if the core team needs to be revised to address the additional legal services.

In step 120, the core team performs the packaged legal services and any other legal services needed. In one implementation, the packaged services include conducting monthly team meetings to coordinate the members of the core team, preparing monthly reports on upcoming due dates, and providing trademark filing and registration services, per the packaged legal services identified. Other legal services can include performing advertising clearance services, performing trademark enforcement, performing telemarketing and sweepstakes counseling, performing privacy and e-commerce counseling, performing patent work, and performing comprehensive brand strategy and implementation services.

Moreover, step 120 can also include receiving data input and storing the data related to the above-mentioned activities and services. For example, as the members of the core team perform the packaged and any other legal services, information related to the performed services may be entered and received into the system. In one example, entered information can include the time spent and the person working on the matter; data with respect to dates, times, and location for meetings, which may also be disseminated via the system; and documentation relating to requests to generate a predetermined report, and generating the same; etc.

In step 125 a determination is made as to whether a predetermined assessment period has elapsed. The predetermined assessment period is an interval at which rates for each of the packaged legal services performed in a subscription may be adjusted. If the assessment period has not yet elapsed, the method proceeds to step 130.

If the assessment period has elapsed, the method proceeds to step 126, wherein a determination is made as to whether the subscription rate needs adjustment. If a determination is made that no adjustment is needed in step 126, the method proceeds to step 130.

If it is determined in step 126 that adjustment to the subscription rate is needed, the method proceeds to step 127, wherein the rate is adjusted. For example, in one embodiment, determining the rate can include analyzing the actual costs incurred during a predetermined period and comparing those costs to the current rate. The predetermined period may include, for example, several billing periods. During the predetermined period, actual legal services costs may be calculated, for example, at an hourly rate based on hours worked information input by core team members. These calculated costs are examined to determine the average amount billed for each billing period. This average amount is then compared to the current rate and the rate is adjusted, if necessary. The rate may also not be adjusted if, for example, it is determined that the core team needs revision or adjustment due to inefficiencies in core team members.

It is also possible to revise the rate using other criteria. For example, the rate may be adjusted to correspond to or account for changes in hourly rates of core team members (e.g., a 10% increase in billing rates having occurred at the time of assessment may result in a 10% increase in the subscription rate). In another example, the subscription rate may be compared to a firmwide average trademark rate and consideration of whether to adjust the subscription rate can be made based on this comparison. In this example, fees for all hourly-billed trademark cases handled by the firm are averaged to find the firmwide average trademark rate, which can be expressed as the amount billed for an average trademark case in one year, or expressed in some other appropriate way.

At periodic intervals, the client is billed in step 130. The client is billed, for example, when a predetermined billing period or other billing trigger has elapsed. In one exemplary implementation, the client is billed monthly or quarterly, although other billing periods are possible. Billing 130 includes charging the subscription rate times the determined subscription for packaged legal services, and additionally charging for any other legal services performed, as well as expense items, such as government filing fees, postal fees, copying fees, and the like.

Step 130 can also include generation of a bill and/or bill report for the client. For example, information to support a bill or bill report can be automatically or manually input, a request for a bill input produced, and a bill compiled and generated having the predefined information thereon. Once the final bill or bill report is completed, the final bill can be disseminated to the client. For example, the final bill can be transmitted electronically to the client via a communication network, such as a wide area network (WAN), a local area network (LAN), or Internet, wireless communication, etc. In an alternative example, the final bill can be printed in hard copy for mail via the postal service or other delivery method.

As such, step 130 can include receiving input, such as instructions to either print or electronically send the final bill. The present invention of this example can provide a menu option on a display screen from which the user may select.

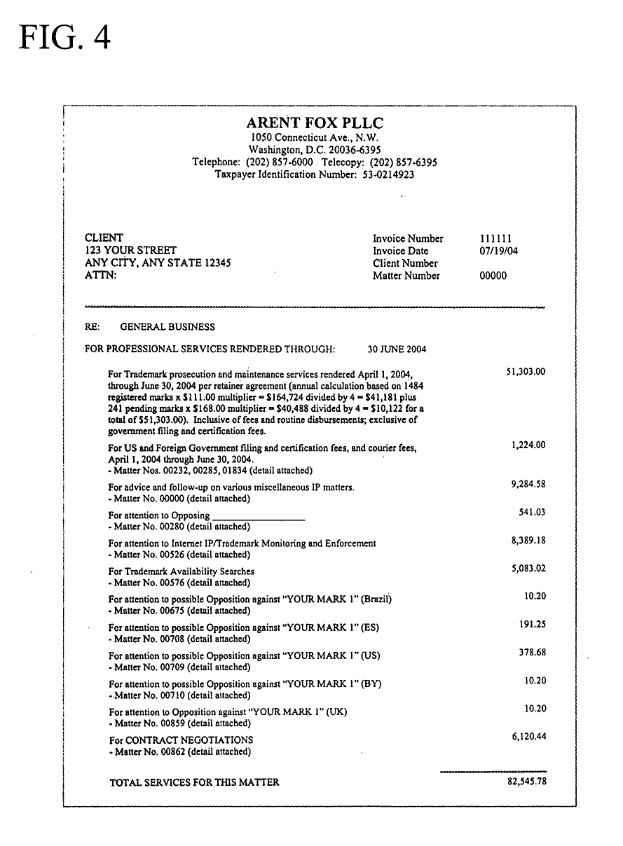

The bill or bill report can include various information, such as a payment amount due and a billing period. In one exemplary embodiment, the billing period is one month. A billing report for this example includes both the billed amount for packaged legal services, based on the subscription rate times the number of subscription services (e.g., number of trademark applications filed and number of trademark registrations), itemized listing or summary information on other legal services, and other billing related information, such as summary information on other costs relating to legal services. FIG. 4 shows an exemplary bill produced in accordance with the present invention.

Once the billing of step 130 is completed the method returns to step 110 for determination of whether the subscription.

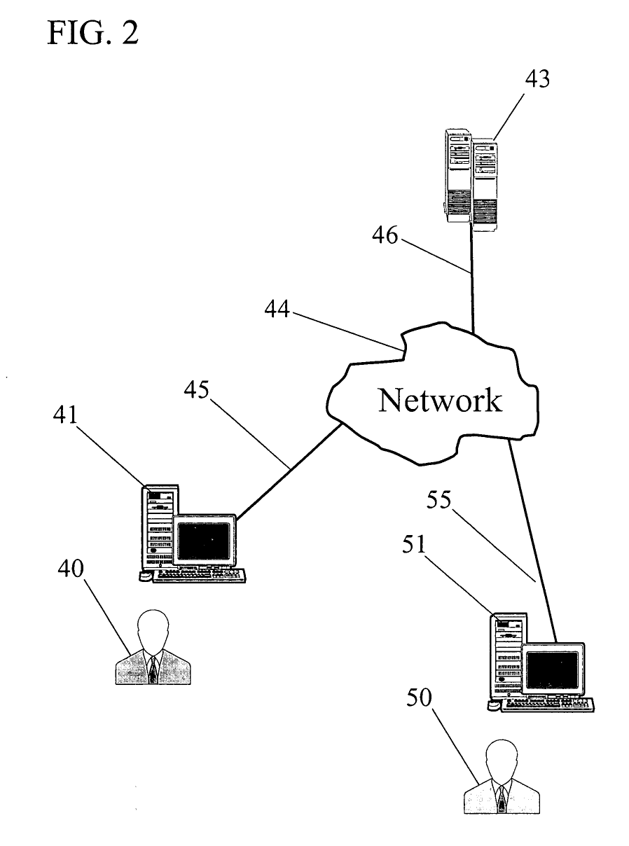

FIG. 2 shows an exemplary system diagram of various hardware and software component and other features in accordance with an embodiment of the present invention. In an embodiment of the present invention, information is input by a user 40, such as a law firm employee, via a terminal 41. The terminal 41 is coupled to a server 43, such as a PC, minicomputer, mainframe computer, microcomputer, or other device having a processor and a repository for data or connection to a repository for maintained data, via a network 44, such as a LAN, WAN, or the Internet, through one or more couplings 45, 46, such as wired, wireless, or fiberoptic connections. In one embodiment, a plurality of users 40 input information via one or more terminals 41 coupled to the network 44. For example, a user 50, such as an employee of a client, inputs information via a terminal 51 coupled to the network 44 via couplings 55, 46. In this embodiment, the user 40 and the user 50 may share information via the system.

In an embodiment of the present invention, trademark data and/or other information is communicated via the network 44 with the server 43. The server 43 receives the information, stores data, and documents the transaction (e.g., electronically).

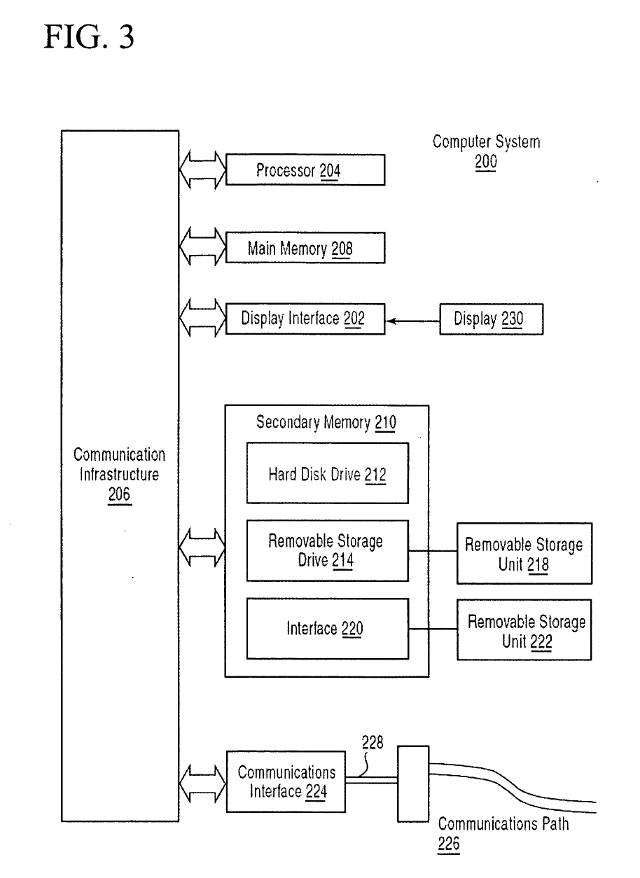

The present invention may be implemented using hardware, software or a combination thereof and may be implemented in one or more computer systems or other processing systems. In one embodiment, the invention is directed toward one or more computer systems capable of carrying out the functionality described herein. An example of such a computer system 200 is shown in FIG. 3.

Computer system 200 includes one or more processors, such as processor 204. The processor 204 is connected to a communication infrastructure 206 (e.g., a communications bus, cross-over bar, or network). Various software embodiments are described in terms of this exemplary computer system. After reading this description, it will become apparent to a person skilled in the relevant art(s) how to implement the invention using other computer systems and/or architectures.

Computer system 200 can include a display interface 202 that forwards graphics, text, and other data from the communication infrastructure 206 (or from a frame buffer not shown) for display on the display unit 230. Computer system 200 also includes a main memory 208, preferably random access memory (RAM), and may also include a secondary memory 210. The secondary memory 210 may include, for example, a hard disk drive 212 and/or a removable storage drive 214, representing a floppy disk drive, a magnetic tape drive, an optical disk drive, etc. The removable storage drive 214 reads from and/or writes to a removable storage unit 218 in a well-known manner. Removable storage unit 218, represents a floppy disk, magnetic tape, optical disk, etc., which is read by and written to removable storage drive 214. As will be appreciated, the removable storage unit 218 includes a computer usable storage medium having stored therein computer software and/or data.

In alternative embodiments, secondary memory 210 may include other similar devices for allowing computer programs or other instructions to be loaded into computer system 200. Such devices may include, for example, a removable storage unit 222 and an interface 220. Examples of such may include a program cartridge and cartridge interface (such as that found in video game devices), a removable memory chip (such as an erasable programmable read only memory (EPROM), or programmable read only memory (PROM)) and associated socket, and other removable storage units 222 and interfaces 220, which allow software and data to be transferred from the removable storage unit 222 to computer system 200.

Computer system 200 may also include a communications interface 224. Communications interface 224 allows software and data to be transferred between computer system 200 and external devices. Examples of communications interface 224 may include a modem, a network interface (such as an Ethernet card), a communications port, a Personal Computer Memory Card International Association (PCMCIA) slot and card, etc. Software and data transferred via communications interface 224 are in the form of signals 228, which may be electronic, electromagnetic, optical or other signals capable of being received by communications interface 224. These signals 228 are provided to communications interface 224 via a communications path (e.g., channel) 226. This path 226 carries signals 228 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 214, a hard disk installed in hard disk drive 212, and signals 228. These computer program products provide software to the computer system 200. The invention is directed to such computer program products.

Computer programs (also referred to as computer control logic) are stored in main memory 208 and/or secondary memory 210. Computer programs may also be received via communications interface 224. Such computer programs, when executed, enable the computer system 200 to perform the features of the present invention, as discussed herein. In particular, the computer programs, when executed, enable the processor 204 to perform the features of the present invention. Accordingly, such computer programs represent controllers of the computer system 200.

In an embodiment where the invention is implemented using software, the software may be stored in a computer program product and loaded into computer system 200 using removable storage drive 214, hard drive 212, or communications interface 224. The control logic (software), when executed by the processor 204, causes the processor 204 to perform the functions of the invention as described herein. In another embodiment, the invention is implemented primarily in hardware using, for example, hardware components, such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. A method for managing brands for products and services internationally, comprising:
receiving identification of a package of legal services;
receiving a selection for membership of a core team;
determining a subscription for the package of legal services; and
generating a bill based on the package of legal services, any legal services performed, the subscription, and a subscription rate.

2. The method of claim 1, wherein the package of legal services includes trademark application filings and trademark registrations.

3. The method of claim 2, wherein the performed legal services include at least one service included in the package of legal services.

4. The method of claim 2, wherein the package of legal services further includes at least one service selected from a group consisting of conducting meetings on a predetermined basis and generating reports.

5. The method of claim 2, wherein the subscription includes the number of legal services in the package of legal services performed.

6. The method of claim 1, wherein the performed legal services include at least one service not included in the package of legal services.

7. The method of claim 6, wherein the at least one service not included in the package of legal services is selected from a group consisting of providing advertisement clearance services, enforcing trademarks, performing patent services, and counseling on issues with respect to telemarketing, sweepstakes, privacy and e-commerce.

8. The method of claim 1, further comprising:
displaying a plurality of individuals for consideration for membership of the core team.

9. The method of claim 1, further comprising:
receiving a selection for other legal services to be performed.

10. The method of claim 9, wherein, if the selection is received for other legal services to be preformed, a determination is made whether to revise the membership of the core team.

11. The method of claim 1, further comprising:
determining whether an assessment period has elapsed.

12. The method of claim 11, wherein, if the assessment period has elapsed, determining whether the subscription rate is to be adjusted.

13. The method of claim 2, wherein generating a bill based on the package of legal services, any legal services performed, the subscription, and a subscription rate includes:
multiplying a trademark application rate by a number of trademark applications filed to product a trademark application fee; and
multiplying a trademark registration rate by a number of trademark registrations to produce a trademark registrations fee.

14. The method of claim 1, wherein generating a bill based on the package of legal services, any legal services performed, the subscription, and a subscription rate includes:
receiving data with respect to services performed on trademark cases for the predetermined client;
receiving a multiplier associated with the predetermined client; and
multiplying the multiplier by a number of trademark cases.

15. The method of claim 7, wherein generating a bill based on the package of legal services, any legal services performed, the subscription, and a subscription rate comprises:
incorporating costs of each of the at least one service not included in the package of legal services.

16. A computer program product comprising a computer usable medium having control logic stored therein for causing a computer to provide interactive assistance with performing a transaction between a financial institution and an end user, the control logic comprising:
first computer readable program code means for receiving identification of a package of legal services;
second computer readable program code means for receiving a selection for membership of a core team;
third computer readable program code means for determining a subscription for the package of legal services; and
fourth computer readable program code means for generating a bill based on the package of legal services, any legal services performed, the subscription, and a subscription rate.

17. A system for global brand management, comprising:
a terminal;
a repository accessible by the terminal;
wherein identification of a package of legal services is received;
wherein a selection for membership of a core team is received;
wherein a subscription for the package of legal services is determined; and
wherein a bill based on the package of legal services, any legal services performed, the subscription, and a subscription rate is generated.

18. The system of claim 17, wherein the terminal is selected from a group consisting of a personal computer, a minicomputer, a main frame computer, a microcomputer, a hand held device, and a telephonic device.

19. The system of claim 17, wherein the terminal is coupled to a server.

20. The system of claim 19, wherein the server is selected from a group consisting of a personal computer, a minicomputer, a microcomputer, and a main frame computer.

21. The system of claim 19, wherein the server is coupled to a network.

22. The system of claim 21, wherein the network is the Internet.

23. The system of claim 21, wherein the server is coupled to the network via a coupling.

24. The system of claim 23, wherein the coupling is selected from a group consisting of a wired connection, a wireless connection, and a fiberoptic connection.

25. The system of claim 19, wherein the repository is housed on a server.
